(19) United States
(12) Patent Application Publication
(10) Pub. No.: US 2024/0070604 A1
(43) Pub. Date: Feb. 29, 2024

(54) LINKING DONORS OR VOLUNTEERS WITH NEARBY PERSONS IN NEED

(71) Applicant: Joy Wang, WOODINVILLE, WA (US)

(72) Inventor: Joy Wang, WOODINVILLE, WA (US)

(21) Appl. No.: 17/899,628

(22) Filed: Aug. 31, 2022

(51) Int. Cl. G06Q 10/08; G06Q 30/02

(52) U.S. Cl. CPC G06Q 10/0836; G06Q 30/0203; G06Q 30/0205

(57) ABSTRACT

A computing system is configured to access a first set of data associated with a first plurality of donors and a second set of data associated with a second plurality of persons in need. The computing system is further configured to receive an indication from a first device associated with a donor, indicating at least (1) one or more items available for donation by the donor, (2) a first location where the item is located, and (3) a time when the item is ready to be picked up at the first location. The computing system is further configured to select one or more persons in need among the second plurality of persons in need based on the first location and one or more second locations of the second plurality of persons in need, and send a notification to one or more second devices associated with the persons in need.

### BACKGROUND

Many non-profit organizations are tasked to help persons in need, such as (but not limited to) persons experiencing homelessness. Such non-profit organizations often collect donations from donors, and then distribute donations to the persons in need. As such, the donations are generally limited to non-perishable goods, e.g., canned food.

However, there are many restaurants in the market. Approximately 85% of the food that isn't used in a typical American restaurant is thrown out while only a small percentage is recycled or donated. Additionally, many persons in need do not have a means of transportation. Thus, it is difficult for such persons in need to travel to a designated location to access donated goods.

Furthermore, existing social networks, such as Facebook® or LinkedIn®, are designed to allow peers and friends to network and communicate with each other in a symmetrical manner. However, such existing social networks are not fit for linking different groups of users, such as (but not limited to) volunteers (and/or donors) with persons in need, where the different groups of users are intended to communicate with each other in an asymmetrical manner.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The embodiments described herein are related to a computing system, a method, and/or a computer program product for linking donors and persons in need. The computing system is configured to access a first set of data associated with a first plurality of donors and a second set of data associated with a second plurality of persons in need. The computing system is also configured to receive an indication from a first device associated with a donor among the first plurality of donors, indicating at least (1) one or more items available for donation by the donor, (2) a first location where the one or more items are located, and (3) a time when the item is ready to be picked up at the first location. In response to receiving the indication, the computing system is configured to select one or more persons in need among the second plurality of persons in need based on the first location and one or more second locations of the second plurality of persons in need. The computing system then sends a first notification to one or more second devices associated with the selected one or more persons in need, notifying the selected one or more persons in need about the one or more items to be donated by the donor.

In some embodiments, the indication further indicates a total volume of the one or more items that are available at the first location. In some embodiments, selecting the one or more persons in need is further based on the total volume of the one or more items.

In some embodiments, the second locations are obtained based on locations of the one or more second devices associated with the selected one or more persons in need. In some embodiments, selecting the one or more persons includes identifying one or more second locations that are within a predetermined distance from the first location, and selecting the one or more persons in need corresponding to the one or more second locations that are within the predetermined distance to receive the first notification.

In some embodiments, the computing system is further configured to receive a first response from at least one second device, indicating whether the corresponding person in need plans to pick up the item to be donated at the first location at the time. In some embodiments, in response to receiving the first response from the at least one second device, the computing system in turn passes the first response to the first device.

In some embodiments, the computing system is further configured to maintain a calendar configured to record one or more donation events. In response to receiving the indication from the first device associated with the donor, the computing system generates a donation event. The donor is set as an organizer of the donation event, and the selected one or more persons in need are set as potential participants of the donation event.

In some embodiments, the computing system is further configured to send a second notification to the first device or the one or more second devices during or before the time of the recorded donation event, reminding the donor or the selected one or more persons in need of the donation event. In some embodiments, the computing system is further configured to receive a second response from at least one second device during or after the donation event, indicating whether the corresponding person in need has received at least one of the one or more items.

In some embodiments, the computing system is further configured to receive a third response from the first device during or after the donation event, indicating that all of the one or more items have been donated. In some embodiments, in response to receiving the third response, the computing system is further configured to send a third notification to the one or more second devices, notifying the persons in need that the item is no longer available.

In some embodiments, the computing system is further configured to send a request to the first device or at least one second device after the donation event, asking for feedback from the donor or the corresponding person in need. In some embodiments, the feedback indicates whether the donor or the corresponding person in need had a positive experience during the donation event, and the computing system records the feedback relationally with a data record associated with the donor or a data record associated with the corresponding person in need. In some embodiments, in response to receiving a negative experience from the donor or the person in need, the computing system avoids pairing the donor with the corresponding person in need in a future donation event.

In some embodiments, the computing system is further configured to register a new donor in the first set of data. Registering the new donor includes recording at least a name, a contact, and a geographical location of the new donor. In some embodiments, the computing system is further configured to register a new person in need in the second set of data. Registering the new person in need includes recording at least a name, a contact, and a geographical area of the new person in need.

In some embodiments, the donor is an individual or an organization. For example, in some embodiments, the donor is a restaurant, and the item to be donated includes surplus food from the restaurant. In some embodiments, the donor is a clothing store, and the item to be donated includes surplus clothing from the clothing store.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be considered to be limiting in scope, embodiments will be described and explained with additional specificity and details through the use of the accompanying drawings in which:

FIG. 1 illustrates an example environment in which the principles described herein are implemented;

FIG. 2 illustrates another example environment in which a service computing system is configured to link users in a donor group and users in a person in need group;

FIG. 3 illustrates an example map showing a first location where one or more items available for donations are located and one or more second locations of persons in need;

FIG. 4 illustrates an example architecture of a service computing system;

FIG. 5 illustrates an example architecture of a person in need device;

FIGS. 6A and 6B illustrate example user interfaces that may be displayed at a person in need device;

FIG. 7 illustrates an example architecture of a donor device;

FIG. 8 illustrates an example user interface that may be displayed at a donor device;

FIG. 9 illustrates a flowchart of an example method for linking donors and persons in need; and

FIG. 10 illustrates an example computing device in which the principles described herein may be employed.

### DETAILED DESCRIPTION

Many non-profit organizations are tasked to help persons in need, such as (but not limited to) persons experiencing homelessness. Such non-profit organizations often collect donations from donors, and then manually distribute donations to the persons in need. As such, donors are often required to take their donations to designated locations. However, many persons in need do not have the means for transportation. Thus, it is difficult for such persons in need to travel to the designated locations to access donated goods.

This phenomenon also limits the donated food to non-perishable goods, e.g., canned food. On the other hand, there are so many restaurants in the market. Approximately 85% of the food that isn't used in a typical American restaurant is thrown out, while only a small percentage is recycled or donated because such a restaurant does not have the means to instantly communicate with the nearby persons in need when surplus food is available for donation.

Existing social network platforms are often used for people, such as (but not limited to) friends, colleagues, and/or persons with similar interest, to network and communicate with their peers in a symmetric manner. For example, Facebook® is designed to allow friends and family members to share their recent events and status. As another example, LinkedIn® is designed to allow colleagues or professionals to share their career-related events and status. Users in these existing social networks generally share a similar role in the data system that maintains the records of these users. A first user and a second user in such an existing social network can equally initiate or block communications with each other, i.e., communicating in a symmetric manner.

However, such existing social network platforms are not designed for communications between different social groups that take on different roles, such as (but not limited to) a donor group and a person in need group. In particular, such different social groups communicate with each other in different and/or asymmetric manners. For example, donors and donation recipients are two different social groups. Generally, donors decide when and what they would like to donate, and persons in need can decide whether they want the donated items, while they generally cannot demand donors donate specific items.

Furthermore, such existing social networks provide users with mobile apps, which are often heavyweight and consume a significant amount of hardware resources. For example, Facebook®'s mobile app is more than 300 megabytes. Users in certain social groups, such as (but not limited to) persons in need, may not have sophisticated devices to run such mobile apps.

The principles described herein solve the above-described problem by implementing a new service computing system, linking different social groups and allowing members in different social groups to communicate in an asymmetric manner. Devices of the users may or may not be required to install a lightweight mobile app. In some embodiments, an existing text message app is repurposed to allow users in a particular group to directly or indirectly communicate with users in another group.

In some embodiments, the different social groups include a first group and a second group. Only members in the first group are allowed to initiate certain communications, and members in the second group can only respond to the communications initiated by the members of the first group based on predetermined rule sets.

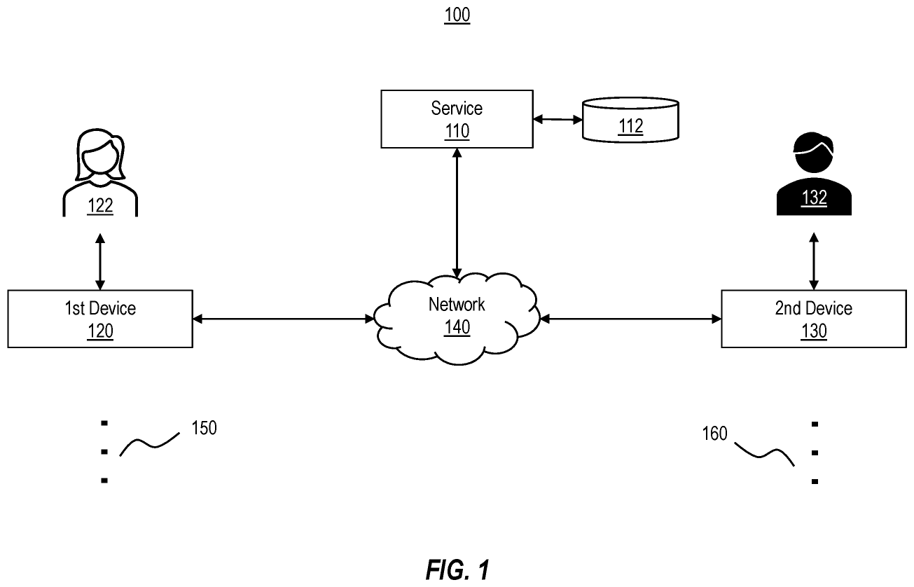

FIG. 1 illustrates an example environment 100 in which the principles described herein are implemented. As illustrated in FIG. 1, a service computing system 110 is configured to communicate with a first device 120 and a second device 130 via a network 140. The first device 120 is associated with a first user 122, who belongs to a first group. The second device 130 is associated with a second user 130, who belongs to a second group. Ellipsis 150 represents that there may be any number of first devices and their corresponding users who belong to the first group. Similarly, ellipsis 160 represents that there may be any number of second devices and their corresponding users who belong to the second group.

The service computing system 110 has access to a data system 112 that records a first set of data associated with users in the first group and a second set of data associated with users in the second group. The service computing system 100 is configured to link members of the first group and members of the second group, allowing the members of the first group and members of the second group to communicate in an asymmetric manner. Such an asymmetric manner may be set based on a set of rules. For example, in some embodiments, for safety purposes, members of a certain group may not be allowed to disclose their real identity, and members of another group may be required to disclose their real identity. As another example, for practical reasons, only members of a particular group are allowed to initiate communications, and members of another group are only allowed to respond to communications initiated by members of the particular group.

In some embodiments, the service computing system 100 is further configured to schedule events involving the linked members. In some embodiments, the service computing system 110 is configured to allow only users in the first group to initiate certain events, and users in the second group can only respond to the events initiated by the users of the first group based on predetermined rule sets.

For example, in some embodiments, the first group and the second group include a donor group (or a volunteer group) and a person in need group. In some embodiments, only the members of the donor group (or the volunteer group) are allowed to initiate a new donation event (or a new volunteer event). In some embodiments, the first group and the second group include a mentor group and a mentee group. In some embodiments, only the members of the mentor group are allowed to initiate a meet-up event.

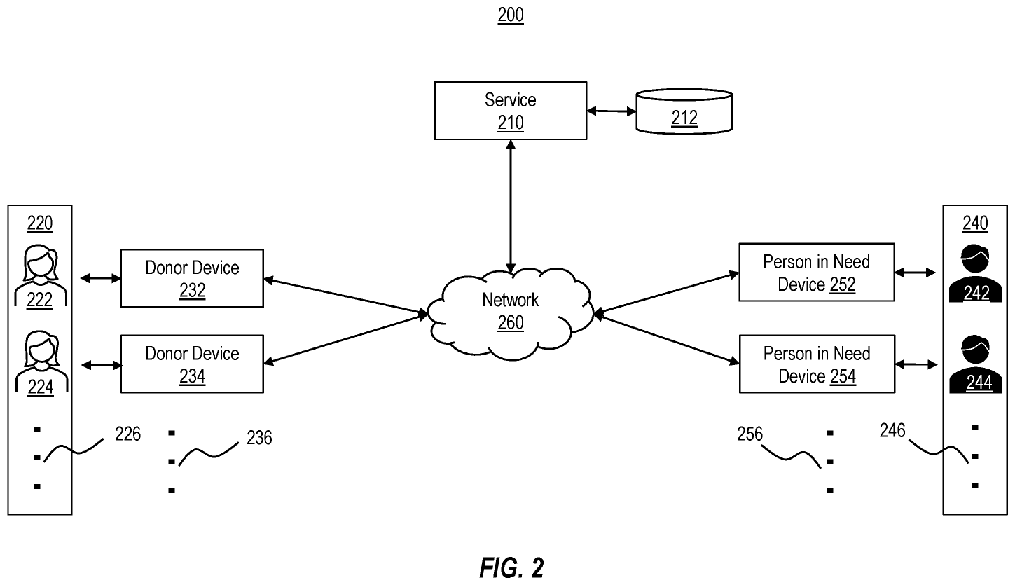

FIG. 2 illustrates another example environment 200 (which corresponds to the environment 100 of FIG. 1), in which a service computing system 210 is configured to link users (i.e., donors) in a donor group 220 and users (i.e., persons in need) in a person in need group 240. Similar to the service computing system 110 of FIG. 1, the service computing system 210 is configured to access a data system 212 that records a first set of data associated with donors in the donor group 220 and a second set of data associated with persons in need in the persons in need group 240.

As illustrated, the donor group 220 includes a first plurality of donors 222 and 224, each of which is associated with a respective donor device 232, 234. The ellipsis 226 and 235 represent that there may be any number of donors in the donor group 220, and that there may be any number of donor devices associated with these donors. The person in need group 240 includes a second plurality of persons in need 242 and 244, each of which is associated with a respective person in need device 252, 254. The ellipsis 246 and 256 represent that there may be any number of persons in need in the person in need group 240, and that there may be any number of person in need devices associated with these persons in need.

Each of the donor devices 232, 234 and person in need device 252, 254 is configured to communicate with the service computing system 210 via a network 260. In some embodiments, the service computing system 210 is configured to receive an indication from a donor device 232 or 234 associated with a donor 222 or 224 among the first plurality of donors 222, 224, indicating at least an item available for donation by the donor, a first location where the item is located, and a time when the item is ready to be picked up at the first location. In response to receiving the indication, the service computing system 210 is configured to select one or more persons in need among the second plurality of persons in need 252, 254 based on the first location and second locations of the second plurality of persons in need. The computing system then sends a first notification to one or more second devices associated with the one or more persons in need, notifying the persons in need about the items to be donated by the donor.

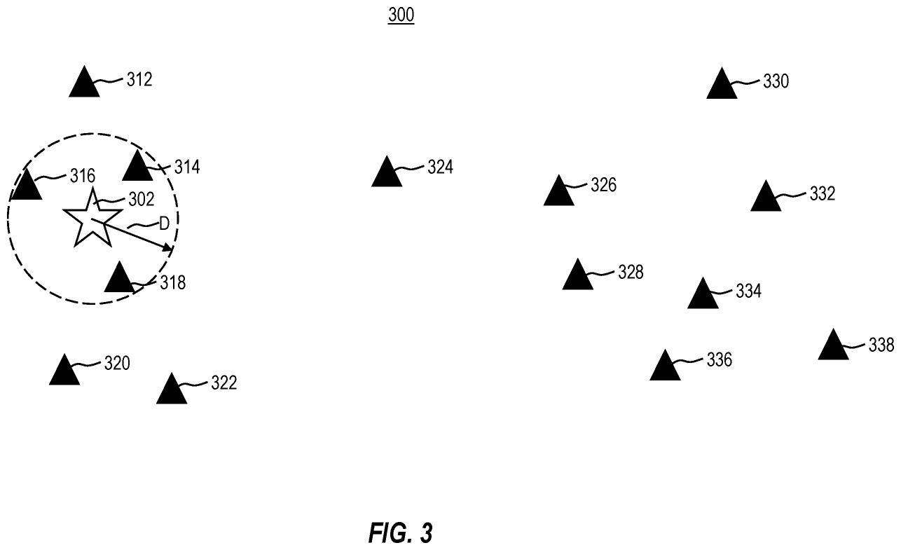

FIG. 3 illustrates an example map showing a first location where one or more items available for donation are located (represented by a star 302) and one or more second locations of a second plurality of persons in need (represented by black triangles 312-338). In some embodiments, the second locations 312-338 are obtained based on locations of the one or more second devices 252, 254 associated with the one or more persons in need 242, 244. In some embodiments, selecting the one or more persons in need includes identifying one or more second locations that are within a predetermined distance D from the first location 302, and selecting the one or more persons in need corresponding to the one or more second locations 314, 316, 318 that are within the predetermined distance D to receive the first notification.

In some embodiments, the indication further indicates a total volume of the items that are available at the first location. In some embodiments, selecting the one or more persons in need is further based on the total volume of the items. For example, when the total volume of the items is sufficient for a first number (N) of persons in need, a second number (M) may be computed based on the first number, and the second number (M) of persons in need are selected to receive the first notification, where M≥N.

In some embodiments, the service computing system 210 is further configured to receive a first response from at least one second device, indicating whether the corresponding person in need plans to pick up the item to be donated at the first location at the time. In response to receiving the first response from the second device, the service computing system 210 passes the first response to the first device. In some embodiments, when there are not enough persons in need who have responded to the first notification, the service computing system 210 is further configured to compute a third number (M′) based on the number of first responses received, and identify an additional third number (M′) persons in need to receive the first notification to ensure that all the donated items are likely to be taken by persons in need.

In some embodiments, the service computing system 210 is further configured to maintain a calendar configured to record one or more donation events. In response to receiving the indication from the first device associated with the donor, the service computing system generates a donation event. In some embodiments, the donor is set as an organizer of the donation event, and the one or more persons in need are set as potential participants of the donation event.

In some embodiments, the service computing system 210 is further configured to send a second notification to the first device or the second device on or before the time of the recorded donation event, reminding the donor or the persons in need of the donation event. In some embodiments, the computing system is further configured to receive a second response from the second device during or after the donation event, indicating whether the corresponding person in need has received the item.

In some embodiments, the service computing system 210 is further configured to receive a third response from the first device during or after the donation event, indicating that all the item has been donated. In some embodiments, in response to receiving the third response, the service computing system 210 is further configured to send a third notification to the one or more second devices, notifying the persons in need that the item is no longer available.

In some embodiments, the service computing system 210 is further configured to send a request to the first device or the second device after the donation event, asking for feedback from the donor or the person in need. In some embodiments, the feedback indicates whether the donor or the person in need had a positive experience during the donation event, and the service computing system records the feedback relationally with a data record associated with the person in need or a data record associated with the donor. In some embodiments, in response to receiving a negative experience from the donor or the person in need, the service computing system avoids pairing the donor with the person in need in a future donation event.

In some embodiments, the service computing system 210 is further configured to register a new donor in the first set of data. Registering the new donor includes recording at least a name, a contact, and a geographical location of the new donor. In some embodiments, the computing system is further configured to register a new person in need in the second set of data. Registering the new person in need includes recording at least a name, a contact, and a geographical area of the new person in need.

In some embodiments, the donor is an individual. In some embodiments, the donor is an organization. For example, in some embodiments, the donor is a restaurant, and the item to be donated includes surplus food from the restaurant. In some embodiments, the donor is a clothing store, and the item to be donated includes surplus clothing from the clothing store.

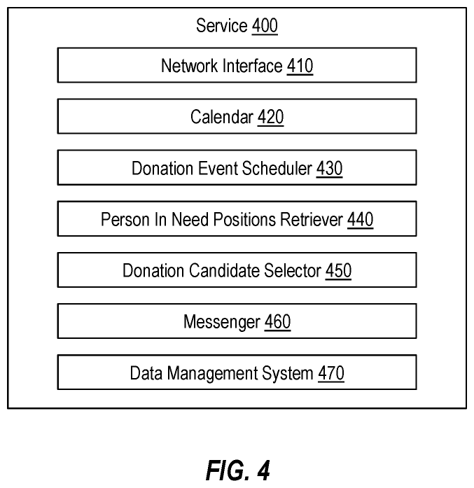

FIG. 4 illustrates an example architecture of a service computing system 400, which corresponds to the service computing system 110 of FIG. 1 or 210 of FIG. 2. The service computing system 400 includes a network interface 410 configured to communicate with the donor devices 232, 234 and person in need devices 252, 254. The service computing system 400 further includes a calendar 420 and a donation event scheduler 430. The donation event scheduler 430 is configured to schedule one or more donation events, and the calendar 420 is configured to record the scheduled one or more donation events.

In some embodiments, the service computing system 400 also includes a person in need positions retriever 440 configured to obtain one or more second locations of the persons in need. In some embodiments, the one or more second locations are received from the one or more person in need devices 252, 254. In some embodiments, the service computing system 400 also includes a donation candidate selector 450 configured to identify one or more persons in need among the second plurality of persons in need 240. In some embodiments, the selection is based on the one or more second locations of the persons in need and a first location of the donation event. Alternatively, or in addition, the selection is based on a total volume of items available for donation.

The service computing system 400 also includes a messenger 460 configured to receive messages from, and/or generate and send messages to the donor devices and/or the persons in need devices. In some embodiments, the service computing system 400 also includes a data management system 470 configured to manage a first set of data associated with donors and a second set of data associated with persons in need.

For example, in some embodiments, the service computing system 400 is configured to receive a message from a donor device, indicating at least (1) one or more items that are available for donation by the donor, (2) a first location where the one or more items are located, and (3) a time when the one or more items are ready to be picked up at the first location. In response to receiving the message from the donor device, the person in need positions retriever 440 is configured to retrieve the one or more second locations of the second plurality of persons, and the donation candidate selector 450 is configured to select one or more persons in need among the second plurality of persons in need based on the first location and the one or more second locations of the second plurality of persons in need. After that, the messenger 460 is configured to generate and send a first notification to the selected one or more person in need devices associated with the one or more persons in need, notifying the one or more persons in need about the items to be donated by the donor.

In some embodiments, the messenger 460 is further configured to receive a first response from at least one person in need device, indicating whether the corresponding person in need plans to pick up the item to be donated at the first location at the time. In some embodiments, in response to receiving the first response from the person in need device, the messenger 460 is further configured to pass the first response to the donor device.

In some embodiments, in response to receiving the indication from the first device associated with the donor, the donation event scheduler 430 is further configured to generate a donation event and record the donation event on the calendar 420. In some embodiments, the donor is set as an organizer of the donation event, and the selected one or more persons in need are set as potential participants of the donation event.

In some embodiments, the calendar 420 is further configured to cause the messenger 460 to generate and send a second notification to the donor device or the one or more persons in need devices before or during the time of the recorded donation event, reminding the donor or the selected one or more persons in need of the donation event.

In some embodiments, the messenger 460 is further configured to receive a second response from at least one person in need device during or after the donation event, indicating whether the corresponding person in need has received at least one of the one or more items.

In some embodiments, the messenger 460 is further configured to receive a third response from the donor device during or after the donation event, indicating that all of the one or more items have been donated. In some embodiments, in response to receiving the third response, the messenger is further configured to generate and send a third notification to the one or more persons in need devices, notifying that the selected one or more persons in need that the one or more items are no longer available.

In some embodiments, the messenger 460 is further configured to send a request to the donor device and/or the person in need devices after the donation event, asking for feedback from the donor or the selected persons in need. In some embodiments, the request is a simple yes or no question, asking whether the donor or each person in need has a positive or a negative experience. In some embodiments, the request is a multiple-choice question, asking the donor or each person in need to choose from one of a plurality of possible responses. In some embodiments, the request is a question that allows the donor or each person in need to respond freely in their own words.

In some embodiments, the data management system 470 is further configured to record the feedback relationally with a data record associated with the person in need and/or a data record associated with the donor. In some embodiments, in response to receiving negative feedback from the donor or a person in need, the service computing system 400 updates the donation candidate selector 450, causing the donation candidate selector 450 to avoid pairing the same donor with the same person in need in a future donation event.

In some embodiments, the data management system 470 is further configured to register a new donor in the first set of data. In some embodiments, registering the new donor includes recording at least a name, a contact, and a geographical location of the new donor. Alternatively, or in addition, the data management system 470 is further configured to register a new person in need in the second set of data. In some embodiments, registering the new person in need includes recording at least a name, a contact, and a geographical area of the new person in need.

In some embodiments, the donor is an individual. In some embodiments, the donor is an organization. For example, in some embodiments, the donor is a restaurant, and the one or more items to be donated include surplus food of the restaurant. In some embodiments, the donor is a clothing store, and the one or more items to be donated include surplus clothing of the clothing store.

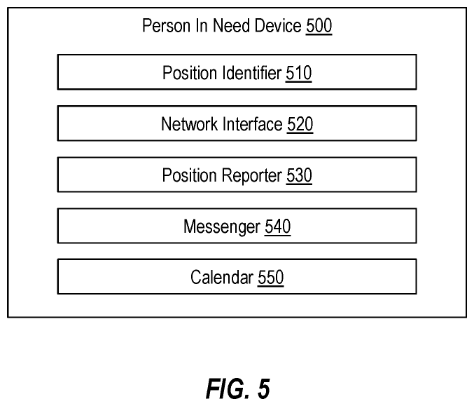

FIG. 5 illustrates an example architecture of a person in need device 500, which corresponds to the person in need device 252, 254 of FIG. 2. The person in need device 500 includes a position identifier 510. In some embodiments, the position identifier 510 includes a global positioning system (GPS) configured to identify positions of the device 500. In some embodiments, the position identifier 510 is configured to use a wireless signal emitted by a nearby device, such as (but not limited to a Bluetooth signal and/or Wi-Fi signal) to obtain a position of the nearby device and then in turn identify a position of the device 500 that is relative to the nearby device.

The person in need device 500 also includes a network interface 520 configured to communicate with the service computing system 400 via a network. In some embodiments, the network interface 520 includes a 2G, 3G, 4G, and/or 5G network interface configured to communicate with the service computing system 400 over 2G, 3G, 4G, and/or 5G networks. In some embodiments, the network interface 520 includes a Wi-Fi interface configured to communicate with the service computing system 400 over Wi-Fi networks. In some embodiments, the network interface 520 includes a Bluetooth interface configured to communicate with nearby Bluetooth devices, which in turn pass the communication to the service computing system 400 over the Internet.

In some embodiments, the person in need device 500 also includes a position reporter 530 configured to report its positions to the service computing system 400 via the network interface 520. In some embodiments, the person in need device 500 further includes a messenger 540 configured to receive messages from and/or send messages to the service computing system 400. In some embodiments, the person in need device 500 further includes a calendar app 550 configured to be at least partially synchronized with the calendar 420 at the service computing system 400.

In some embodiments, the person in need device 500 is a mobile phone, on which one or more mobile apps are installed. In some embodiments, the one or more mobile apps include a dedicated mobile app configured to communicate with the service computing system. In some embodiments, the person in need device 500 is configured to use a generic messenger app to communicate with the service computing system. In some embodiments, the person in need device 500 is a single-purpose device configured to communicate with the service computing system 400 solely.

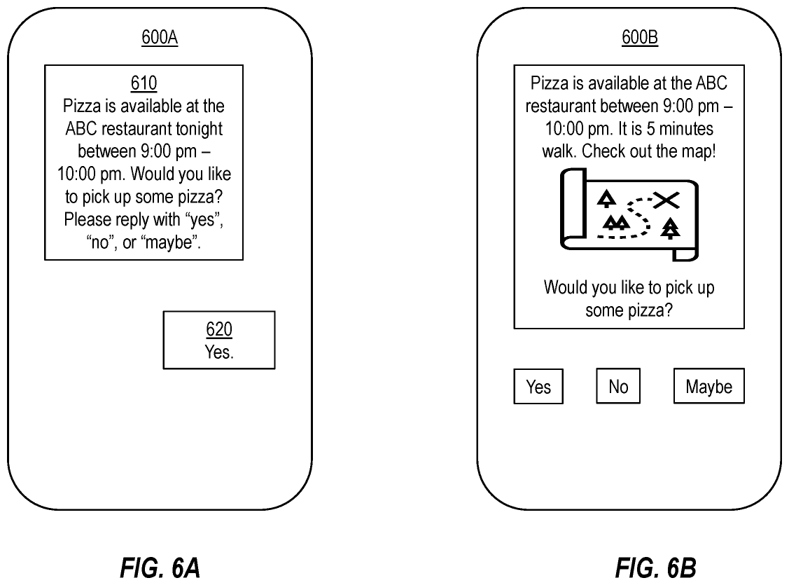

FIGS. 6A and 6B illustrate example user interfaces 600A and 600B that may be displayed at a person in need device, corresponding to the person in need device 500 of FIG. 5. As illustrated in FIG. 6A, in some embodiments, the interface 600A is a simple text message 610 sent from the service computing system 400 to the person in need device 500, stating “Pizza is available at the ABC restaurant tonight between 9:00 pm-10:00 pm. Would you like to pick up some pizza? Please reply with ‘yes’, ‘no’, or ‘maybe’.” A user of the person in need device 500 can simply respond to the text message with another text message 620, stating “yes”, “no”, or “maybe”.

FIG. 6B illustrates another example user interface 600B. As illustrated in FIG. 6B, in some embodiments, the interface 600B includes a combination of text, image, and interactive elements, allowing a user to interact therewith. For example, the interface 600B includes a map, showing a direction from a position of the person in need device 500 to a location of a donation event. The interface 600B also shows a yes button, a no button, and a maybe button for a user to select. The user can select any one of the buttons to indicate whether he or she intends to participate the donation event.

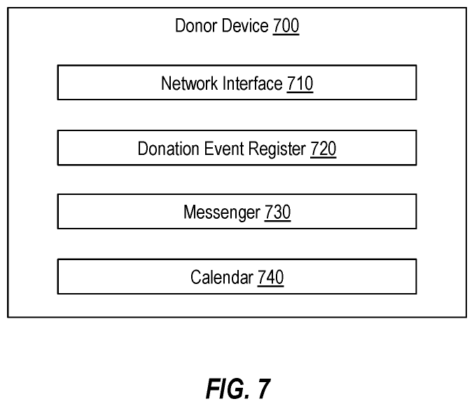

FIG. 7 illustrates an example architecture of a donor device 700, which corresponds to the donor device 232, 234 of FIG. 2. As illustrated in FIG. 7, the donor device 700 includes a network interface 710 configured to communicate with the service computing system 400. The donor device 700 also includes a donation event register 720. In some embodiments, the donor event register 720 is a dedicated application installed on the donor device 700 configured to allow the donor device 700 to register donation events with the service computing system 400. In some embodiments, the donor event register 720 is a generic browser configured to access a donor portal webpage provided by the service computing system 400. In some embodiments, the donor device 700 further includes a messenger 730 configured to receive messages from and/or send messages to the service computing system 400. In some embodiments, the donor device 700 further includes a calendar app 740 configured to at least partially synchronize with the calendar 420 of the service computing system 400.

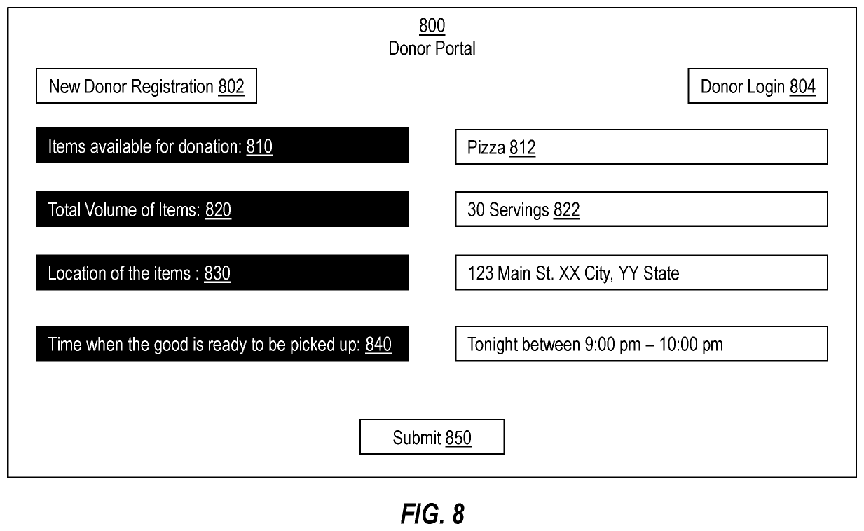

FIG. 8 illustrates an example user interface 800 that may be displayed at a donor device 700. As illustrated in FIG. 8, the user interface 800 includes a donor portal for a donor to register a donation event. In some embodiments, the donor portal 800 is displayed on a dedicated application installed on the donor device 700. In some embodiments, the donor portal 800 is a webpage displayed on a generic browser app installed at the donor device 700. As illustrated, a new donor may be required to register themselves via a link 802, and an existing donor may be required to log into their existing account via a link 804.

After the donor logs into their account, the donor is then required to provide some information related to the donor event. For example, the donor may be required to provide items available for donation 810. As illustrated, the donor enters pizza 812 as the items available for donation. In some embodiments, the donor may also be required to provide a total volume of the items 820. As illustrated, the donor enters 30 servings 822 as the total volume of the items. In some embodiments, the donor may also be required to provide a location of the items 830. As illustrated, the donor enters “123 Main St. XX City, YY State.” In some embodiments, the donor may also be required to provide a time when the good is ready to be picked up 840. As illustrated, the donor enters “Tonight between 9:00 pm-10:00 pm.” After entering the required information, the donor can click the submit button 850 to transmit the information to the service computing system 400.

In response to receiving the information from the donor device 700, the service computing system 400 in turn generates and records a donation event, selects one or more persons in need, and sends a notification to one or more person in need devices corresponding to the selected one or more persons in need.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

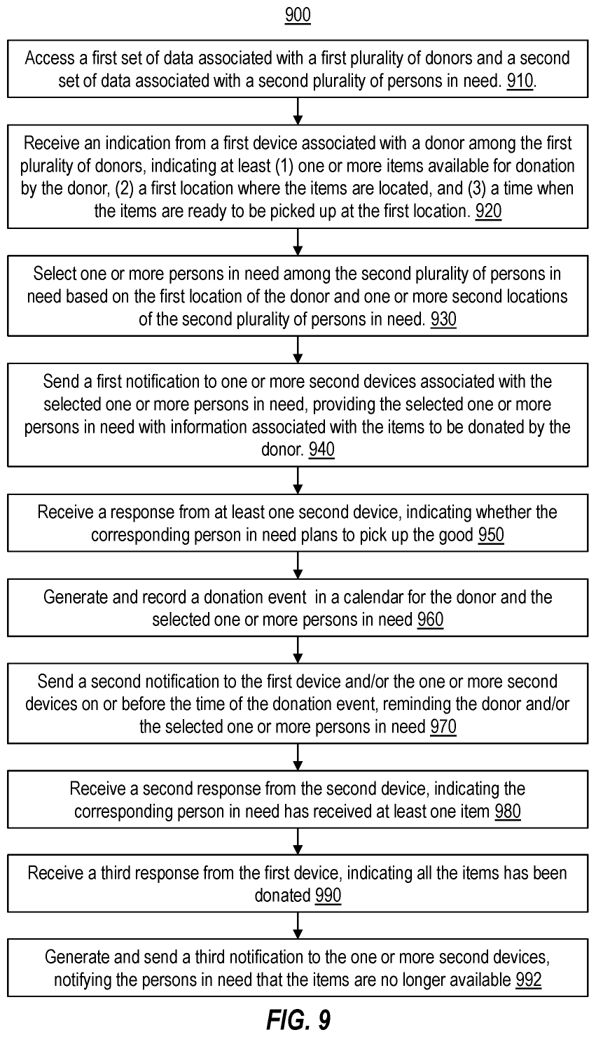

FIG. 9 illustrates a flowchart of an example method 900 for linking donors and persons in need. The method 900 is implemented at a computing system, corresponding to the service computing system 110 of FIG. 1, 210 of FIGS. 2, and/or 400 of FIG. 4. The method 900 includes accessing a first set of data associated with a first plurality of donors and a second set of data associated with a second plurality of persons in need (act 910). The method 900 further includes receiving an indication from a first device associated with a donor among the plurality of donors, indicating at least (1) one or more items available for donation by the donor, (2) a first location where the one or more items are located, and (3) a time when the one or more items are ready to be picked up at the first location (act 920). The method 900 further includes selecting one or more persons in need among the second plurality of persons in need based on the first location of the donor and one or more second locations of the second plurality of persons in need (act 930). The method 900 further includes sending a first notification to one or more second devices associated with the selected one or more persons in need, providing the selected one or more persons in need with information associated with the one or more items to be donated by the donor (act 940).

In some embodiments, the method 900 further includes receiving a response from at least one second device, indicating whether the corresponding person in need plans to pick up the good at the first location (act 950). In some embodiments, the method 900 further includes generating and recording a donation event in a calendar for the donor and the selected one or more persons in need (act 960). For example, in some embodiments, the donor is set as the organizer of the donation event, and the selected one or more persons in need are set as potential participants.

In some embodiments, the method 900 further includes sending a second notification to the first device and/or the second device don or before the time of the donation event, reminding the donor and/or the selected one or more persons in need of the donation event (act 970). In some embodiments, the method 900 further includes receiving a second response from the second device, indicating the corresponding person in need has received at least one of the one or more items (act 980). In some embodiments, the method 900 further includes receiving a third response from the first device, indicating that all of the one or more items have been donated (act 990). In some embodiments, in response to receiving the third response, a third notification is generated and sent to the one or more second devices, notifying the selected one or more persons in need that the one or more items are no longer available (act 992).

Note, even though the discussions provided herein are primarily based on communication patterns between a donor group and a persons in need group, the principles described herein are not limited to this scenario. The similar principles can be implemented in other asymmetric communication patterns for other social groups, such as (but not limited to) (1) communications between a volunteer group and a person in need group, (2) communications between a mentor group and a mentee group, and/or (3) communications between a day labor job provider group and a day worker group.

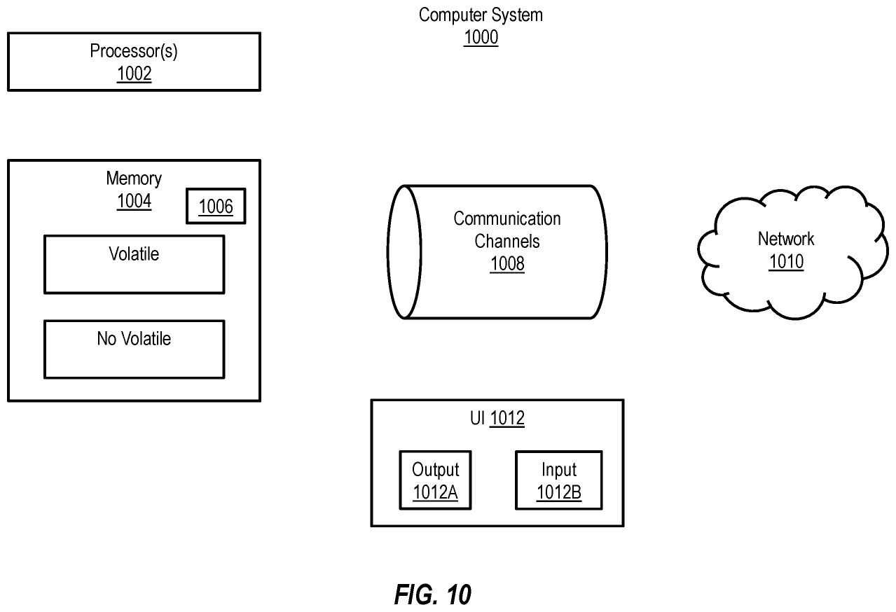

Finally, because the principles described herein may be performed in the context of a computing device (for example, each of the service computing system 110, 210, 400, first device 120, second device 130, donor device 232, 234, 700, and/or person in need device 252, 254, 500 includes one or more computing devices) some introductory discussion of a computing device will be described with respect to FIG. 10.

Computing devices are now increasingly taking a wide variety of forms. Computing devices may, for example, be hand-held devices, appliances, laptop computers, desktop computers, mainframes, distributed computing devices, data centers, or even devices that have not conventionally been considered a computing device, such as wearables (e.g., glasses). In this description and in the claims, the term “computing device” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing device. A computing device may be distributed over a network environment and may include multiple constituent computing devices.

As illustrated in FIG. 10, in its most basic configuration, a computing device 1000 typically includes at least one hardware processing unit 1002 and memory 1004. The processing unit 1002 may include a general-purpose processor and may also include a field-programmable gate array (FPGA), an application-specific integrated circuit (ASIC), or any other specialized circuit. The memory 1004 may be physical system memory, which may be volatile, non-volatile, or some combination of the two. The term “memory” may also be used herein to refer to non-volatile mass storage such as physical storage media. If the computing device is distributed, the processing, memory and/or storage capability may be distributed as well.

The computing device 1000 also has thereon multiple structures often referred to as an “executable component”. For instance, memory 1004 of the computing device 1000 is illustrated as including executable component 1006. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing device, whether such an executable component exists in the heap of a computing device, or whether the executable component exists on computer-readable storage media.

In such a case, one of ordinary skill in the art will recognize that the structure of the executable component exists on a computer-readable medium such that, when interpreted by one or more processors of a computing device (e.g., by a processor thread), the computing device is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hardcoded or hard-wired logic gates, that are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description above, embodiments are described with reference to acts that are performed by one or more computing devices. If such acts are implemented in software, one or more processors (of the associated computing device that performs the act) direct the operation of the computing device in response to having executed computer-executable instructions that constitute an executable component. For example, such computer-executable instructions may be embodied in one or more computer-readable media that form a computer program product. An example of such an operation involves the manipulation of data. If such acts are implemented exclusively or near-exclusively in hardware, such as within an FPGA or an ASIC, the computer-executable instructions may be hardcoded or hard-wired logic gates. The computer-executable instructions (and the manipulated data) may be stored in the memory 1004 of the computing device 1000. Computing device 1000 may also contain communication channels 1008 that allow the computing device 1000 to communicate with other computing devices over, for example, network 1010.

While not all computing devices require a user interface, in some embodiments, the computing device 1000 includes a user interface system 1012 for use in interfacing with a user. The user interface system 1012 may include output mechanisms 1012A as well as input mechanisms 1012B. The principles described herein are not limited to the precise output mechanisms 1012A or input mechanisms 1012B as such will depend on the nature of the device. However, output mechanisms 1012A might include, for instance, speakers, displays, tactile output, holograms, and so forth. Examples of input mechanisms 1012B might include, for instance, microphones, touchscreens, holograms, cameras, keyboards, mouse or other pointer input, sensors of any type, and so forth.

Embodiments described herein may comprise or utilize a special purpose or general-purpose computing device, including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing device. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing device.

A “network” is defined as one or more data links that enable the transport of electronic data between computing devices and/or modules and/or other electronic devices. When information is transferred or provided over a network or another communications connection (either hard-wired, wireless, or a combination of hard-wired or wireless) to a computing device, the computing device properly views the connection as a transmission medium. Transmissions media can include a network and/or data links that can be used to carry desired program code means in the form of computer-executable instructions or data structures and which can be accessed by a general-purpose or special-purpose computing device. Combinations of the above should also be included within the scope of computer-readable media.

Further, upon reaching various computing device components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing device RAM and/or to less volatile storage media at a computing device. Thus, it should be understood that storage media can be included in computing device components that also (or even primarily) utilize transmission media.

Computer-executable instructions comprise, for example, instructions and data which, when executed at a processor, cause a general-purpose computing device, special purpose computing device, or special purpose processing device to perform a certain function or group of functions. Alternatively or in addition, the computer-executable instructions may configure the computing device to perform a certain function or group of functions. The computer-executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing device configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, data centers, wearables (such as glasses) and the like. The invention may also be practiced in distributed system environments where local and remote computing devices, which are linked (either by hard-wired data links, wireless data links, or by a combination of hard-wired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures have discussed various computing devices which may correspond to the computing device 1000. The computing devices of the remaining figures include various components or functional blocks that may implement the various embodiments disclosed herein, as will be explained. The various components or functional blocks may be implemented on a local computing device or may be implemented on a distributed computing device that includes elements resident in the cloud or that implement aspect of cloud computing. The various components or functional blocks may be implemented as software, hardware, or a combination of software and hardware. The computing devices of the remaining figures may include more or less than the components illustrated in the figures, and some of the components may be combined as circumstances warrant. Although not necessarily illustrated, the various components of the computing devices may access and/or utilize a processor and memory, such as processing unit 1002 and memory 1004, as needed to perform their various functions.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising:
one or more processors; and
one or more computer-readable hardware storage devices having stored thereon computer-executable instructions that are structured such that, when executed by the one or more processors, configure the computing system to perform the following:
access a first set of data associated with a first plurality of donors and a second set of data associated with a second plurality of persons in need;
receive an indication from a first device associated with a donor among the first plurality of donors, indicating at least (1) one or more items that are available for donation by the donor, (2) a first location where the item is located, and (3) a time when the item is ready to be picked up at the first location;
select one or more persons in need among the second plurality of persons in need based on the first location and one or more second locations of the second plurality of persons in need; and
send a first notification to one or more second devices associated with the selected one or more persons in need, notifying the selected one or more persons in need about the one or more items to be donated by the donor.

2. The computing system of claim 1, wherein the indication further indicates a total volume of the one or more items that are available at the first location.

3. The computing system of claim 2, wherein selecting the one or more persons in need is further based on the total volume of the one or more items.

4. The computing system of claim 1, wherein the second locations are obtained based on locations of the one or more second devices associated with the selected one or more persons in need.

5. The computing system of claim 4, wherein selecting the one or more persons includes identifying one or more second locations that are within a predetermined distance from the first location, and selecting the one or more persons in need corresponding to the one or more second locations that are within the predetermined distance to receive the first notification.

6. The computing system of claim 1, wherein the computing system is further configured to receive a first response from at least one second device, indicating whether the corresponding person in need plans to pick up the item to be donated at the first location at the time.

7. The computing system of claim 6, wherein in response to receiving the first response from the at least one second device, the computing system passes the first response to the first device.

8. The computing system of claim 6, wherein the computing system is further configured to:
maintain a calendar configured to record one or more donation events; and
in response to receiving the indication from the first device associated with the donor, generate a donation event, and record the donation event on the calendar; and
wherein the donor is set as an organizer of the donation event, and the selected one or more persons in need are set as potential participants of the donation event.

9. The computing system of claim 8, wherein the computing system is further configured to send a second notification to the first device or the second devices during or before the time of the recorded donation event, reminding the donor or the selected one or more persons in need of the donation event.

10. The computing system of claim 8, wherein the computing system is further configured to receive a second response from at least one second device during or after the donation event, indicating whether the corresponding person in need has received at least one of the one or more items.

11. The computing system of claim 8, wherein the computing system is further configured to receive a third response from the first device during or after the donation event, indicating that all of the one or more items have been donated.

12. The computing system of claim 11, wherein in response to receiving the third response, the computing system is further configured to send a third notification to the one or more second devices, notifying the selected one or more persons in need that the one or more items are no longer available.

13. The computing system of claim 8, wherein the computing system is further configured to send a request to the first device or at least one second device after the donation event, asking for feedback from the donor or the corresponding person in need.

14. The computing system of claim 13, wherein the feedback indicates whether the donor or the corresponding person in need had a positive experience during the donation event, and
the computing system records the feedback relationally with a data record associated with the donor or a data record associated with the corresponding person in need.

15. The computing system of claim 14, wherein in response to receiving a negative feedback from the donor or the corresponding person in need, the computing system avoids pairing the donor with the corresponding person in need in a future donation event.

16. The computing system of claim 1, wherein the computing system is further configured to:
register a new donor in the first set of data, registering the new donor comprising recording at least a name, a contact, and a geographical location of the new donor, or
register a new person in need in the second set of data, registering the new person in need comprising recording at least a name, a contact, and a geographical area of the new person in need.

17. The computing system of claim 1, wherein the donor is a restaurant, and the one or more items to be donated include surplus food of the restaurant.

18. The computing system of claim 1, wherein the donor is a clothing store, and the one or more items to be donated include surplus clothing of the clothing store.

19. A method implemented at a computing service for linking donors and persons in need, the method comprising:
accessing a first set of data associated with a first plurality of donors and a second set of data associated with a second plurality of persons in need;
receiving an indication from a first device associated with a donor among the first plurality of donors, indicating at least (1) one or more items that are available for donation by the donor, (2) a first location where the item is located, and (3) a time when the item is ready to be picked up at the first location;
selecting one or more persons in need among the second plurality of persons in need based on the first location and one or more second locations of the second plurality of persons in need; and
sending a first notification to one or more second devices associated with the one or more persons in need, notifying the one or more persons in need about the items to be donated by the donor.

20. A computer program product comprising one or more hardware storage devices having stored thereon computer-executable instructions that are structured such that, when the computer-executable instructions are executed by one or more processors of a computing system, the computer-executable instructions cause the computing system to perform the following:
access a first set of data associated with a first plurality of donors and a second set of data associated with a second plurality of persons in need;
receive an indication from a first device associated with a donor among the first plurality of donors, indicating at least (1) one or more items that are available for donation by the donor, (2) a first location where the item is located, and (3) a time when the item is ready to be picked up at the first location;
select one or more persons in need among the second plurality of persons in need based on the first location and one or more second locations of the second plurality of persons in need; and
send a first notification to one or more second devices associated with the one or more persons in need, notifying the one or more persons in need about the items to be donated by the donor.
